(19) United States
(12) Patent Application Publication
(10) Pub. No.: US 2019/0343121 A1
(43) Pub. Date: Nov. 14, 2019

(54) Cinmethylin Microcapsules with a Shell Made of Tetramethylxylylene Diisocyanate and a Polyamine with at Least Three Amine Groups

(71) Applicant: BASF Agro B.V., Arnhem (NL)

(72) Inventors: Klaus KOLB, Limburgerhof (DE); Marc NOLTE, Limburgerhof (DE); Wolfgang GREGORI, Limburgerhof (DE); Martina SCHMITT, Limburgerhof (DE); Diana FRANZ, Limburgerhof (DE); Helmut KRAUS, Limburgerhof (DE)

(21) Appl. No.: 16/466,754

(22) PCT Filed: Nov. 29, 2017
(86) PCT No.: PCT/EP2017/080746

§ 371 Date: Jun. 5, 2019

(30) Foreign Application Priority Data
Dec. 7, 2016 (EP) 16202678.5

(51) Int. Cl. A01N 43/90; A01N 25/28

(52) U.S. Cl. CPC A01N 43/90; A01N 25/28

(57) ABSTRACT

The present invention relates to a a composition comprising microcapsules, which comprise a polyurea shell and a core, wherein the core comprises cinmethylin and the shell comprises a polymerization product of a tetramethylxylylene diisocyanate, and a polyamine with at least three amine groups, and where the polymerization product comprises less than 5 wt % of further isocyanate monomers in polymerized form, based on the weight of the tetramethylxylylene diisocyanate; a method for preparing the composition comprising the steps of contacting water, the cinmethylin, the tetramethylxylylene diisocyanate, and the polyamine; and to a method of controlling undesired plant growth, wherein the composition is allowed to act on the soil and/or on undesired plants and/or on the crop plants and/or on their environment.

The present invention relates to a composition comprising microcapsules, which comprise a polyurea shell and a core, wherein the core comprises cinmethylin and the shell comprises a polymerization product of a tetramethylxylylene diisocyanate, and a polyamine with at least three amine groups; a method for preparing the composition comprising the steps of contacting water, the cinmethylin, the tetramethylxylylene diisocyanate, and the polyamine; and to a method of controlling undesired plant growth, wherein the composition is allowed to act on the crop plants to be protected from the respective pest, on the soil and/or on undesired plants and/or on the crop plants and/or on their environment. The present invention comprises combinations of preferred features with other preferred features.

Agrochemical microcapsules which comprise a polyurea shell and a core which comprises cinmethylin are known, but still need some improvement. WO 94/13139 discloses microcapsules comprising cinmethylin, whose shell is made of polyurethanes obtained by the reaction of hexamethylenediamine and PAPI® 2027 (a polymethylene polyphenylisocyanate from Dow Chemical).

WO 2015/165834 discloses microcapsules comprising cinmethylin, whose shell is made of polyurethanes obtained by the reaction of Bayhydur® XP 2547 (an anionic water-dispersible polyisocyanate based on hexamethylene diisocyanate), dicyclohexylmethane diisocyanate and a polyethyleneimine.

The objects were solved by a composition comprising microcapsules, wherein the microcapsules comprise a polyurea shell and a core, wherein the core comprises cinmethylin and the shell comprises a polymerization product of

a) a tetramethylxylylene diisocyanate, and

b) a polyamine with at least three amine groups.

Cinmethylin is a selective, pre-emergence, systemic herbicide useful for the control of annual grass weeds, for example in rice. The common name cinmethylin herein refers to the racemic mixture (±)-2-exo-(2-methylbenzyloxy)-1-methyl-4-isopropyl-7-oxabicyclo[2.2.1]heptane (also referred to as the “exo-(±)-isomers”, CAS RN 87818-31-3)

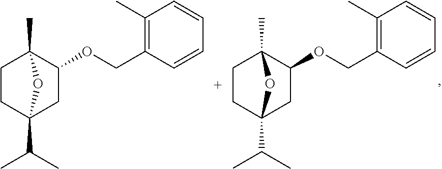

any of its individual enantiomers or any non-racemic mixture thereof. The racemic mixture contains equal parts of the two enantiomers (+)-2-exo-(2-M ethylbenzyloxy)-1-methyl-4-isopropyl-7-oxabicyclo[2.2.1]heptane (also referred to as the “exo-(+)-isomer”, CAS RN 87818-61-9) and (−)-2-exo-(2-Methylbenzyloxy)-1-methyl-4-isopropyl-7-oxabicyclo[2.2.1]heptane (also referred to as the “exo-(−)-isomer”, CAS RN 87819-60-1). The exo-(±)-isomers, the exo-(+)-isomer and the exo-(−)-isomer including their preparation and herbicidal properties are disclosed in EP 0 081 893 A2 (see Examples 29, 34, 35 and 62). Further preparation methods of these compounds are described in U.S. Pat. No. 4,487,945 (see Embodiments 46 and 48). The racemic mixture (±)-2-exo-(2-Methylbenzyloxy)-1-methyl-4-isopropyl-7-oxabicyclo[2.2.1]heptane is also described in The Pesticide Manual, Fourteenth Edition, Editor: C. D. S. Tomlin, British Crop Production Council, 2006, entry 157, pages 195-196 with its IUPAC name (1RS,2SR,4SR)-1,4-epoxy-p-menth-2-yl 2-methylbenzyl ether and its Chemical Abstracts name exo-(±)-1-methyl-4-(1-methylethyl)-2-[(2-methylphenyl)methoxy]-7-oxabicyclo[2.2.1]heptane. Cinmethylin is a liquid, which is barely soluble in water (0.063 g·L⁻¹ at 20° C.), but soluble in organic solvents. It has a boiling point of 312° C. (Pesticide Science, 1987, 21, Nr. 2, 143-153).

A suitable tetramethylxylylene diisocyanate may be meta- or para-substituted tetramethylxylylene diisocyanate. Preferably the tetramethylxylylene diisocyanate is the compound of the formula (II)

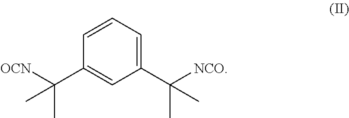

The polymerization product comprises less than 5 wt %, preferably less than 3 wt %, and in particular less than 1 wt % of further isocyanate monomers in polymerized form, based on the weight of the tetramethylxylylene diisocyanate. In another form the polymerization product is essentially free of further isocyanate monomers in polymerized form. The term “further isocyanate monomer” may refer to any compound which comprises at least one (preferably at least two) isocyanate groups, and which may be suitable as monomer for preparing polyurea.

The polyamine has at least three amine groups. Mixtures of different polyamines are also possible. Preferably, the polyamine is an aliphatic polyamine which has two primary amine groups and at least one secondary and/or tertiary amine group. Suitable polyamines are ethylene amines, which are usually commercially available from Huntsman Corp., USA or Dow Chemical Co., USA. More preferably, the polyamine is diethylenetriamine (DETA), linear or branched triethylenetetramine (TETA), N,N′-bis-(2-aminoethyl)piperazine) (Bis AEP), tetraethylenepentamine (TEPA), 4-(2-aminoethyl)-N-(2-aminoethyl)-N′-{2-{(2-aminoethyl)amino}ethyl}-1,2-ethanediamine) (AETETA), 1-(2-aminoethyl)-4-[(2-aminoethyl)amino)ethyl]-piperazine) (AEPEEDA), pentaethylenehexamine (PEHA), hexaethyleneheptamine (HEHA), or mixtures thereof. Even more preferred are triethylenetetramine (TETA), tetraethylenepentamine (TEPA), pentaethylenehexamine (PEHA), hexaethyleneheptamine (HEHA), and mixtures thereof.

In another preferred form the polyamine is a compound of formula (I)

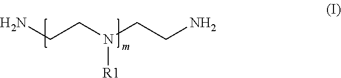

where m is an integer from 1 to 8, and R1 is H or methyl. The index m is preferably an integer from 2 to 5, more preferably from 3 to 4, and in particular 3. R1 is preferably H. Preferably, m is an integer from 2 to 5, and R1 is H.

The polyurea shell comprises usually at least 45 wt %, preferably at least 55 wt %, and in particular at least 65 wt % of the tetramethylxylylene diisocyanate. The polyurea shell comprises usually 45 to 90 wt %, preferably 55 to 85 wt %, and in particular 65 to 78 wt % of the tetramethylxylylene diisocyanate. The wt % of the tetramethylxylylene diisocyanate in the polyurea shell may refer to the total amount of monomers.

The polyurea shell comprises usually up to 55 wt %, preferably up to 45 wt %, and in up to 35 wt % of the polyamine (e.g. of the formula (I), wherein m is an integer from 1 to 8). The polyurea shell comprises usually 15 to 55 wt %, preferably 20 to 45 wt %, and in particular 25 to 35 wt % of the polyamine (e.g. of the formula (I), wherein m is an integer from 1 to 8). The wt % of polyamine in the polyurea shell may refer to the total amount of monomers.

The polymerization product may comprise up to 30 wt %, preferably up to 10 wt %, and in particular up to 5 wt % of further amine monomers in polymerized form, based on the weight of the polyamine. The term “further amine monomer” may refer to any compound which comprises at least one (preferably at least two) amine groups, and which may be suitable as monomer for preparing polyurea.

The weight ratio of the core to the polyurea shell is usually in the range from 50:1 to 5:1, preferably from 40:1 to 10:1, and in particular from 30:1 to 15:1. The weight of the core may be based on the amounts of the cinmethylin, and optionally the water immiscible organic solvent, and optionally the further solvents. The weight of the polyurea shell may be based on the amounts of the tetramethylxylylene diisocyanate and the polyamine.

In another preferred form the polyurea shell comprises 45 to 90 wt % of the tetramethylxylylene diisocyanate, 15 to 55 wt % of the polyamine (e.g. of the formula (I) wherein m is an integer from 2 to 5), less than 5 wt % further isocyanate monomers, and the weight ratio of the core to the polyurea shell is in the range from 50:1 to 5:1.

In another preferred form the polyurea shell comprises 55 to 85 wt % of the tetramethylxylylene diisocyanate, 20 to 45 wt % of the polyamine (e.g. of the formula (I) wherein m is an integer from 2 to 5), less than 3 wt % further isocyanate monomers, and the weight ratio of the core to the polyurea shell is in the range from 40:1 to 10:1.

In another preferred form the polyurea shell comprises 65 to 75 wt % of the tetramethylxylylene diisocyanate, 25 to 35 wt % of the polyamine (e.g. of the formula (I) wherein m is an integer from 2 to 5), no further isocyanate monomers, and the weight ratio of the core to the polyurea shell is in the range from 30:1 to 15:1.

Microcapsules with a polyurea shell can be prepared by analogy to prior art. They are preferably prepared by an interfacial polymerization process of a suitable polymer wall forming material, such as a diisocyanate and a diamine. Interfacial polymerization is usually performed in an aqueous oil-in-water emulsion or suspension of the core material containing dissolved therein at least one part of the polymer wall forming material. During the polymerization, the polymer segregates from the core material to the boundary surface between the core material and water thereby forming the wall of the microcapsule. Thereby an aqueous suspension of the microcapsule material is obtainable. Suitable methods for interfacial polymerization processes for preparing microcapsules containing cinmethylin have been disclosed in the prior art. In general, polyurea is formed by reacting at least one diisocyanate with at least one diamine to form a polyurea shell.

The average size of the microcapsules (z-average by means of light scattering; preferably a D_{4,3} average) is 0.5 to 50 μm, preferably 0.5 to 20 μm, more preferably 1 to 15 μm, and especially 2 to 10 μm.

The core of the microcapsules may comprise a water immiscible organic solvent. Suitable examples for water immiscible organic solvents are
a hydrocarbon solvent such a an aliphatic, cyclic and aromatic hydrocarbons (e. g. toluene, xylene, paraffin, tetrahydronaphthalene, alkylated naphthalenes or their derivatives, mineral oil fractions of medium to high boiling point (such as kerosene, diesel oil, coal tar oils));
a vegetable oil such as corn oil, rapeseed oil;
a fatty acid ester such as C₁-C₁₀-alkylester of a C₁₀-C₂₂-fatty acid; or
methyl- or ethyl esters of vegetable oils such as rapeseed oil methyl ester or corn oil methyl ester.

Mixtures of aforementioned water immiscible organic solvents are also possible. The water immiscible organic solvent is usually commercially available, such as the hydrocarbons under the tradenames Solvesso® 200, Aromatic® 200, or Caromax® 28. The aromatic hydrocarbons may be used as naphthalene depleted qualities. Preferred water immiscible organic solvents are hydrocarbons, in particular aromatic hydrocarbons.

Preferably, the water immiscible organic solvent has a solubility in water of up to 20 g/L at 20° C., more preferably of up to 5 g/L and in particular of up to 0.5 g/L.

Usually, the water immiscible organic solvent has a boiling point above 100° C., preferably above 150° C., and in particular above 180° C.

In a preferred form the core of the microcapsule may comprise up to 10 wt %, preferably up to 5 wt %, and in particular up to 1 wt % of the water immiscible organic solvent.

In a more preferred form the core of the microcapsule may comprise less than 1 wt %, preferably less than 0.5 wt %, and in particular less than 0.1 wt % of the water immiscible organic solvent. In another more preferred form the core of the microcapsule is free of the water immiscible organic solvent.

The core of the microcapsules may comprise further solvents, e.g. up to 30 wt %, preferably up to 15 wt %, based on the total amount of all solvents in the core. In another preferred form the core of the microcapsule is free of the further solvent. Further solvents may be water or water miscible solvents. The water miscible organic solvent may have a solubility in water at least 0.5 g/L at 20° C., more preferably of at least 5 g/L and in particular of at least 20 g/L

In a more preferred form the core of the microcapsule may comprise less than 1 wt %, preferably less than 0.5 wt %, and in particular less than 0.1 wt % of an organic solvent. In another more preferred form the core of the microcapsule is free of the organic solvent. Suitable organic solvents are the water immiscible organic solvent and the further solvent.

The core of the microcapsule may comprise at least 90 wt %, preferably at least 95 wt %, and in particular at least 99 wt % of the sum of the cinmethylin, optionally the water-immiscible organic solvent, and optionally the further solvent. In another form the core of the microcapsule may consist of the cinmethylin, optionally the water-immiscible organic solvent, and optionally the further solvent. In yet another form the core of the microcapsule may consist of the cinmethylin.

In a preferred form the core of the microcapsule may comprise at least 90 wt %, preferably at least 95 wt %, and in particular at least 99 wt % of the cinmethylin.

The composition may be an aqueous composition, which may comprise an aqueous phase (e.g. a continuous aqueous phase). The aqueous composition may comprise at least 10 wt %, preferably at least 25 wt %, and in particular at least 35 wt % water. Usually, the microcapsules are suspended in the aqueous phase of the aqueous composition.

Preferably, the composition is an aqueous composition and the aqueous phase comprises a lignosulfonate. Lignosulfonates which are suitable are the alkali metal salts and/or alkaline earth metal salts and/or ammonium salts, for example the ammonium, sodium, potassium, calcium or magnesium salts of lignosulfonic acid. The sodium, potassium and/or calcium salts are very particularly preferably used. Naturally, the term lignosulfonates also encompasses mixed salts of different ions, such as potassium/sodium lignosulfonate, potassium/calcium lignosulfonate and the like, in particular sodium/calcium lignosulfonate.

The lignosulfonate may be based on kraft lignins. Kraft lignins are obtained in a pulping process of lignins with sodium hydroxyde and sodium sulfide. The kraft lignins may be sulfonated to obtain the lignosulfonate.

The molecular mass of the lignosulfonate may vary from 500 to 20000 g/mol. Preferably, the lignosulfonate has a molecular weight of 700 to 10000 g/mol, more preferably from 900 to 7000 g/mol, and in particular from 1000 to 5000 g/mol.

The lignosulfonate is usually soluble in water (e.g. at 20° C.), e.g. at least 5 wt %, preferably at least 10 wt %, and in particular at least 20 wt %.

The aqueous composition comprises usually 0.1 to 5.0 wt %, preferably 0.3 to 3.0 wt %, and in particular 0.5 to 2.0 wt % of the lignosulfonate.

The composition (e.g. the aqueous composition) contains usually at least 1 wt % encapsulated cinmethylin, preferably at least 3 wt % and in particular at least 10 wt %.

The composition may also contain a water-soluble inorganic salt, which may result from the preparation of the microencapsules or which may be added thereafter. If present, the concentration of the water-soluble, inorganic salt may vary from 1 to 200 g/L, preferably from 2 to 150 g/L and especially from 10 to 130 g/L. Water-solubility of the salt means solubility in water of at least 50 g/L, in particular at least 100 g/L or even at least 200 g/L at 20° C.

Such inorganic salts are preferably selected from sulfates, chlorides, nitrates, mono and dihydrogen phosphates of alkali metals, the sulfates, chlorides, nitrates, mono and dihydrogen phosphates of ammonia, chlorides and nitrates of alkaline earth metals and magnesium sulfate. Examples include lithium chloride, sodium chloride, potassium chloride, lithium nitrate, sodium nitrate, potassium nitrate, lithium sulfate, sodium sulfate, potassium sulfate, sodium monohydrogen phosphate, potassium monohydrogen phosphate, sodium dihydrogen phosphate, potassium dihydrogen phosphate, magnesium chloride, calcium chloride, magnesium nitrate, calcium nitrate, magnesium sulfate, ammonium chloride, ammonium sulfate, ammonium monohydrogen phosphate, ammonium dihydrogen phosphate and the like. Preferred inorganic salts are sodium chloride, potassium chloride, calcium chloride, ammonium sulfate and magnesium sulfate with ammonium sulfate and magnesium sulfate being especially preferred.

In another embodiment, the composition does not contain or contains less than 10 g/L in particular less than 1 g/L of the water-soluble inorganic salt.

The composition may comprise a glycol, such as ethylene glycol, propylene glycol. The composition may comprise from 1 to 250 g/L, preferably from 10 to 150 g/L and especially from 30 to 100 g/L of the glycol.

The composition may comprise further auxiliaries outside the microcapsules, e.g. in the aqueous phase of the aqueous composition. Examples for suitable auxiliaries are surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-foaming agents, colorants, tackifiers and binders.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates. The term sulfonates refers to compounds which are different from the ligninsulfonates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a negligible or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-foaming agents are silicones, long chain alcohols, and salts of fatty acids.

The present invention also relates to a method for preparing the composition comprising the steps of contacting water, cinmethylin, the tetramethylxylylene diisocyanate and the polyamine. The contacting may be done by mixing the components, e.g. at temperatures from 20 to 100° C.

In one embodiment the method for preparing the composition comprises the steps of contacting an aqueous phase, which comprises at least one dispersant, with an oil phase comprising cinmethylin and the tetramethylxylylene diisocyanate; the mixture is then emulsified using high-shear equipment; to the resulting emulsion the polyamine is added while stirring is continued with a low shear stirrer. The emulsification and subsequent stirring may be done at temperatures from 20 to 80° C.

The particle size distribution resulting from high-shear stirring is typically characterized by the following parameters: a D₅₀ of 0.5 to 20 μm and a D₉₀ of 5 to 30 μm, more preferably a D₅₀ of 1 to 15 μm and a D₉₀ of 5 to 20 μm; most preferably a D₅₀ of 2 to 10 μm and a D₉₀ of 8 to 15 μm (z-average by means of light scattering).

In a preferred embodiment of the invention the composition is prepared as follows:

Step 1) an oil phase comprising cinmethylin and tetramethylxylylene diisocyanate is added to an aqueous phase at temperatures from 20 to 80° C.; this aqueous phase comprises at least one dispersant; for example, the dispersant may be selected from the group consisting of lignosulfonates, condensed alkyl naphthalene sulfonates or condensed phenol sulphonates, as defined herein; the mixture is then emulsified using high-shear equipment, so that the resulting particle size distribution in the emulsion is characterized by a D₅₀ of 2 to 10 μm and a D₉₀ of 8 to 15 μm (z-average by means of light scattering).

Optionally, the aqueous phase additionally comprises a water-soluble inorganic salt as defined herein below, whereas said salt is preferably selected from sodium chloride, potassium chloride, calcium chloride, ammonium sulfate and magnesium sulfate; and/or an anti-freeze agent, whereas the anti-freeze agent is preferably selected from ethylene and propylene glycol; and/or an anti-foaming agent, for example a silicone defoamer.

Step 2) after emulsification, the emulsification device is replaced by a low shear stirrer and the polyamine is added, preferably as an aqueous solution (5 to 50% by weight, preferably 15 to 35% by weight based on the aqueous solution added). Subsequently, the dispersion is smoothly agitated at 20 to 80° C., preferably for 30 minutes to 150 minutes, more preferably for 60 to 120 minutes.

Optionally, in a third step, the capsule dispersion is treated under stirring with an aqueous finish solution comprising, for example, a dispersant system, an anti-freeze agent, a thickener, a defoamer, or a biocide, or a combination thereof; the pH may be adjusted to pH 6 to 8 by addition of an inorganic or organic acid, for example acetic acid.

The concentration of the water-soluble, inorganic salt in the aqueous phase in step 1) may vary from 2 to 150 g/L, preferably from 10 to 130 g/L and especially from 50 to 100 g/L. Water-solubility of the salt means solubility in water of at least 50 g/L, in particular at least 100 g/L or even at least 200 g/L at 20° C.

Such inorganic salts are preferably selected from sulfates, chlorides, nitrates, mono and dihydrogen phosphates of alkali metals, the sulfates, chlorides, nitrates, mono and dihydrogen phosphates of ammonia, chlorides and nitrates of alkaline earth metals and magnesium sulfate. Examples include lithium chloride, sodium chloride, potassium chloride, lithium nitrate, sodium nitrate, potassium nitrate, lithium sulfate, sodium sulfate, potassium sulfate, sodium monohydrogen phosphate, potassium monohydrogen phosphate, sodium dihydrogen phosphate, potassium dihydrogen phosphate, magnesium chloride, calcium chloride, magnesium nitrate, calcium nitrate, magnesium sulfate, ammonium chloride, ammonium sulfate, ammonium monohydrogen phosphate, ammonium dihydrogen phosphate and the like. Preferred inorganic salts are sodium chloride, potassium chloride, calcium chloride, ammonium sulfate and magnesium sulfate with ammonium sulfate and magnesium sulfate being especially preferred.

The present invention furthermore relates to a method of controlling undesired plant growth, wherein the composition according to the invention is allowed to act on on the soil and/or on undesired plants and/or on the crop plants and/or on their environment.

Examples of suitable crop plants are cereals, for example wheat, rye, barley, triticale, oats or rice; beet, for example sugar or fodder beet; pome fruit, stone fruit and soft fruit, for example apples, pears, plums, peaches, almonds, cherries, strawberries, raspberries, currants or gooseberries; legumes, for example beans, lentils, peas, lucerne or soybeans; oil crops, for example oilseed rape, mustard, olives, sunflowers, coconut, cacao, castor beans, oil palm, peanuts or soybeans; cucurbits, for example pumpkins/squash, cucumbers or melons; fiber crops, for example cotton, flax, hemp or jute; citrus fruit, for example oranges, lemons, grapefruit or tangerines; vegetable plants, for example spinach, lettuce, asparagus, cabbages, carrots, onions, tomatoes, potatoes, pumpkin/squash or capsicums; plants of the laurel family, for example avocados, cinnamon or camphor; energy crops and industrial feedstock crops, for example maize, soybeans, wheat, oilseed rape, sugar cane or oil palm; maize; tobacco; nuts; coffee; tea; bananas; wine (dessert grapes and grapes for vinification); hops; grass, for example turf; sweetleaf (Stevia rebaudania); rubber plants and forest plants, for example flowers, shrubs, deciduous trees and coniferous trees, and propagation material, for example seeds, and harvested produce of these plants.

The term crop plants also includes those plants which have been modified by breeding, mutagenesis or recombinant methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the plant's properties. Such recombinant modifications also comprise posttranslational modifications of proteins, oligo- or polypeptides, for example by means of glycosylation or binding polymers such as, for example, prenylated, acetylated or farnesylated residues or PEG residues.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

Various types of oils, wetters, adjuvants, fertilizer, or micronutrients, and further pesticides (e.g. herbicides, insecticides, fungicides, growth regulators, safeners) may be added to the the agrochemical compositions comprising them as premix or, if appropriate not until immediately prior to use (tank mix). These agents can be admixed with the compositions according to the invention in a weight ratio of 1:100 to 100:1, preferably 1:10 to 10:1.

When employed in plant protection, the amounts of cinmethylin applied are, depending on the kind of effect desired, from 0.001 to 2 kg per ha, preferably from 0.005 to 2 kg per ha, more preferably from 0.05 to 0.9 kg per ha, in particular from 0.05 to 0.6 kg per ha.

The present invention has various advantages: The composition is stable during storage for a long time, for example even at a wide temperature range; the composition may be applied after dilution with water without clogging the spray nozzles; the composition is stable after dilution with water; the composition may be mixed with various other crop protection products and provides better compatibility of the active components (e.g. reduced sedimentation, flocculation, crystallization) when compared with mixtures comprising non-encapsulated cinmethylin; the volatility of the cinmethylin is reduced; the UV sensitivity is reduced; the cinmethylin is more stable after application to the crop; the composition provides better mobility of cinmethylin into soil.

1-15. (canceled)

16. A composition comprising microcapsules, wherein the microcapsules comprise a polyurea shell and a core, wherein the core comprises cinmethylin and the shell comprises a polymerization product of
a) a tetramethylxylylene diisocyanate, and
b) a polyamine with at least three amine groups.

17. The composition of claim 16, wherein the polyamine is a compound of formula (I) 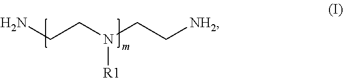
wherein m is an integer from 1 to 8, and R1 is H or methyl.

18. The composition of claim 17, wherein m is an integer from 2 to 5, and R1 is H.

19. The composition of claim 16, wherein the tetramethylxylylene diisocyanate is a compound of formula (II)

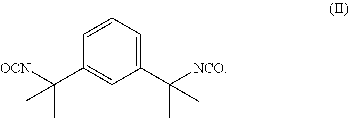

20. The composition of claim 16, wherein the weight ratio of the core to the polyurea shell is in the range from 50:1 to 5:1.

21. The composition of claim 16, wherein the polymerization product comprises less than 5 wt % of further isocyanate monomers in polymerized form, based on the weight of the tetramethylxylylene diisocyanate.

22. The composition of claim 16, wherein the polyurea shell comprises at least 55 wt % of the tetramethylxylylene diisocyanate.

23. The composition of claim 16, wherein the polyurea shell comprises up to 45 wt % of the polyamine.

24. The composition of claim 16, wherein the composition is an aqueous composition and the aqueous phase comprises a lignosulfonate.

25. The composition of claim 24, wherein the lignosulfonate has a molecular weight of up to 10000 g/mol.

26. The composition of claim 24, wherein the composition comprises 0.3 to 3.0 wt % of the lignosulfonate.

27. The composition of claim 16, wherein the core comprises less than 1 wt % of a water immiscible organic solvent.

28. The composition of claim 16, wherein the core comprises less than 0.5 wt % of a water immiscible organic solvent.

29. A method for preparing the composition of claim 16, comprising the steps of contacting water, the cinmethylin, the tetramethylxylylene diisocyanate, and the polyamine.

30. A method of controlling undesired plant growth, wherein the composition of claim 16 is allowed to act on the soil and/or on undesired plants and/or on the crop plants and/or on their environment.

31. The method of claim 30, wherein the polyamine is a compound of formula (I) 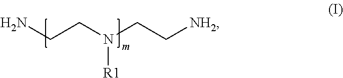
wherein m is an integer from 1 to 8, and R1 is H or methyl.

32. The method of claim 31, wherein m is an integer from 2 to 5, and R1 is H.

33. The method of claim 30, wherein the tetramethylxylylene diisocyanate is a compound of formula (II)

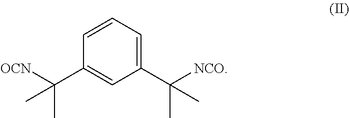

34. The method of claim 30, wherein the weight ratio of the core to the polyurea shell is in the range from 50:1 to 5:1.

35. The method of claim 30, wherein the polymerization product comprises less than 5 wt % of further isocyanate monomers in polymerized form, based on the weight of the tetramethylxylylene diisocyanate.

36. The method of claim 30, wherein the polyurea shell comprises at least 55 wt % of the tetramethylxylylene diisocyanate.

37. The method of claim 30, wherein the polyurea shell comprises up to 45 wt % of the polyamine.

38. The method of claim 30, wherein the composition is an aqueous composition and the aqueous phase comprises a lignosulfonate.

39. The method of claim 38, wherein the lignosulfonate has a molecular weight of up to 10000 g/mol.

40. The method of claim 38, wherein the composition comprises 0.3 to 3.0 wt % of the lignosulfonate.

41. The method of claim 30, wherein the core comprises less than 1 wt % of a water immiscible organic solvent.

42. The method of claim 30, wherein the core comprises less than 0.5 wt % of a water immiscible organic solvent.
